(19) United States
(12) Patent Application Publication
(10) Pub. No.: US 2003/0132049 A1
(43) Pub. Date: Jul. 17, 2003

(54) Parking brake invalift interlock system

(76) Inventors: Milton W. Kurttila, Benton, AR (US); Harry L. Vinson, North Little Rock, AR (US)

Correspondence Address: INTERNATIONAL TRUCK INTELLECTUAL PROPERTY COMPANY,, 4201 WINFIELD ROAD, P.O. BOX 1488, WARRENVILLE, IL, 60555, US

(21) Appl. No.: 10/047,488

(22) Filed: Jan. 14, 2002

(51) Int. Cl. B60R 21/00

(52) U.S. Cl. 180/271

(57) ABSTRACT

A parking brake invalift interlock system that includes electrical communication with a park brake solenoid valve. This solenoid valve in a closed position will prevent air from releasing the park brakes. The solenoid valve is engaged to the circuit of the interlock system such that the valve cannot be opened to release the park brake unless the vehicle ignition is in an ON or energized position, the lift is stowed, and the lift door is closed. The invalid or wheelchair lift, referred to as an invalift, is electrically engaged through the interlock system to the ignition system, a park brake pressure sensor, and a lift door position sensor. As a result, the invalift lift control cannot be operated unless the ignition is ON, there is power to a Lift Switch, the park brake system fluid or air pressure is below a predefined pressure setpoint, and the lift door is opened. The system may further be configured to prevent lift door opening unless the ignition is in the ON position. This would be to ensure that the lift has the power to operate.

### BACKGROUND

This invention relates to a system for a vehicle with an invalid or wheelchair lift. The system provides an interlock with the vehicle parking brake system and vehicle ignition that prevents a driver of the vehicle from moving the vehicle in any gear unless the invalid lift is stowed, the lift door is closed, and the parking brake released. There are regulations that provide some guidance on the controls of a vehicle invalid lift. The regulations indicate that the lift controls should be interlocked with the vehicle brakes, transmission, or door, or shall provide other appropriate mechanisms to ensure that the vehicle cannot be moved when the lift is not stowed and the lift cannot be deployed unless the interlocks or systems are engaged. The regulatory guidance does not provide any specifications as how to accomplish this interlock. Many vehicles that may contain invalid lifts, such as school buses, use parking brake systems that use air to keep the parking brakes engaged. Should the air pressure in the system be reduced, the parking brake actuators are engaged to the release of stored energy in the actuators. If air is bled out of the parking brake actuators or chambers, the actuators engage the park brake and the vehicle may not be moved in any gear. No previous invalid lift system tied the vehicle movement interlock to a reduced air or other actuating fluid pressure to the parking brake actuator.

What is needed is a practical system that locks out vehicle movement of any kind through the air or other fluid pressure sensed position of the park brake and further prevents the release of the park brake until the lift is stowed, the lift door is closed, and vehicle ignition is turned on.

### SUMMARY

An objective of the invention is to provide a vehicle system and a vehicle with the system installed where the vehicle parking brake must be set before an onboard vehicle lift can be operated. More specifically, the objective is that the lift cannot be operated unless the vehicle ignition is energized, there is power to the lift, the park brake operating fluid system is depressurized engaging the park brake, and the lift door is opened. A further objective is to provide that the parking brake cannot be released and the vehicle cannot be moved in any gear until the lift is stowed, the lift door is closed, and the ignition is turned on.

The parking brake invalift interlock system of this invention meets the objectives of the invention. Specifically, the system includes electrical communication with a park brake valve. This valve in a closed position will prevent air or other actuating fluid from releasing the park brakes. The park brake valve is engaged to the circuit of the interlock system such that the valve cannot be opened to release the park brake unless the vehicle ignition is in an ON or energized position, the lift is stowed, and the lift door is closed. The invalid or wheelchair lift, referred to as an invalift, is electrically engaged through the interlock system to the ignition system, a park brake pressure sensor, and a lift door position sensor. As a result, the invalift lift control cannot be operated unless the ignition is ON, there is power to a Lift Switch, the park brake system fluid or air pressure is below a predefined pressure set point, and the lift door is opened. The system may further be configured to prevent lift door opening unless the ignition is in the ON position. This would be to ensure that the lift has the power to operate.

### DRAWINGS

Other objects and advantages of the invention will become more apparent upon perusal of the detailed description thereof and upon inspection of the drawings, in which:

FIG. 1 is a perspective view of a mobile bus vehicle with an invalift and parking brake invalift interlock system installed made in accordance with this invention.

FIG. 2 is a top down partial view of the chassis of the vehicle of FIG. 1.

FIG. 3 is a logic diagram of an invalift control portion of the interlock system of FIG. 1.

FIG. 4 is a logic diagram of a parking brake portion of the interlock system of FIG. 1.

FIG. 5 a logic diagram of an invalift lift door portion of the interlock system of FIG. 1.

FIG. 6 is one embodiment of a circuit for the parking brake invalift interlock system of FIG. 1.

FIG. 7 is a second embodiment for implementing the parking brake invalift interlock system of FIG. 1.

FIG. 8 is an additional embodiment of a circuit for the parking brake invalift interlock system of FIG. 1.

### DETAILS OF INVENTION

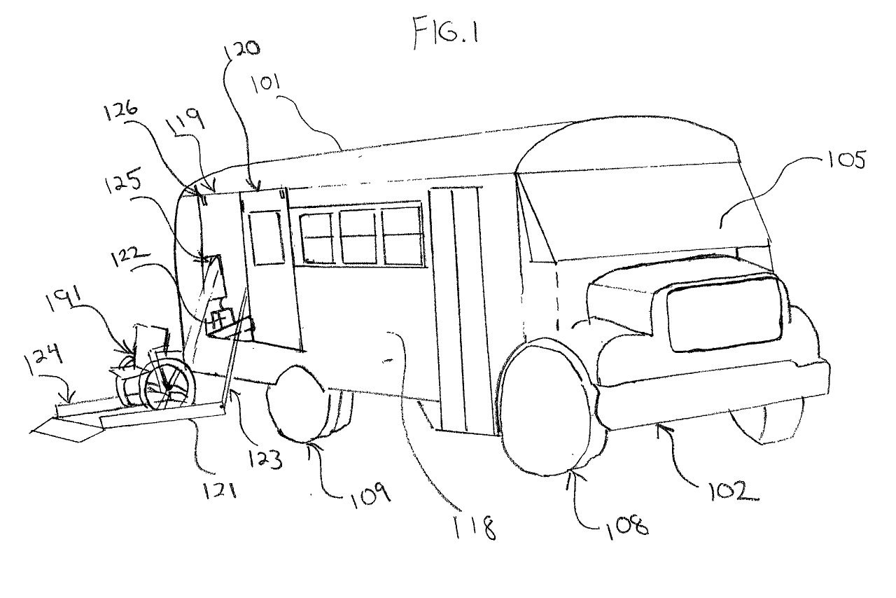

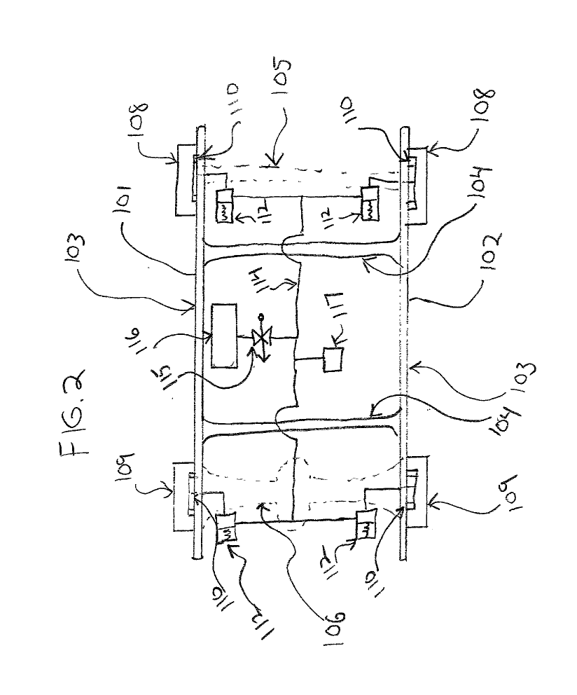

The parking brake invalift interlock system of this invention is well suited for use in a mobile vehicle 101, such as a school bus, commercial bus, or light duty vehicle like a transit van. A school bus vehicle 101 with the system installed is shown in FIGS. 1 and 2. The vehicle 101 has a chassis 102 comprised of two generally parallel frame rails 103, with interconnecting cross members 104. There is a forward axle assembly 105 and a rear axle 106 engaged to the frame rails 103 through a suspension system. The forward axle assembly 105 has front wheels 108, while the rear axle 106 has rear wheels 109. Each of the wheels 108 and 109 has a brake assembly 110. Each brake assembly 110 has an associated brake actuator chamber 112. Each associated brake actuator chamber 112 will engage the park brakes on the associated brake assembly 110 when air or other actuating fluid is bled from the actuator chamber 112. A spring or other potential energy storing device is held in a disengaged position due to the presence of pressurized air or other actuating fluid. The air or other actuating fluid is plumbed from an actuating fluid source 116 through park brake valve 115 to the actuating chambers 112 through tubing or piping 114. Where the actuating fluid is air as in air brakes the fluid source 116 will be a vehicle air tank 116 or air compressor. The park brake valve 115 may be operated in a number ways although a solenoid 115a is described here. Should air brake valve 115 be operated by another means such as hydraulic or air, that source's control would be regulated in a similar fashion as solenoid 115a is described here. In an alternative embodiment, the parking brake system may involve locking a drive shaft engaged to the rear axle 106. The shaft parking brakes, there would be a brake actuator chamber 112 that would engage the drive shaft to lock the shaft. The remainder of the interlock logic to be described here would be the same.

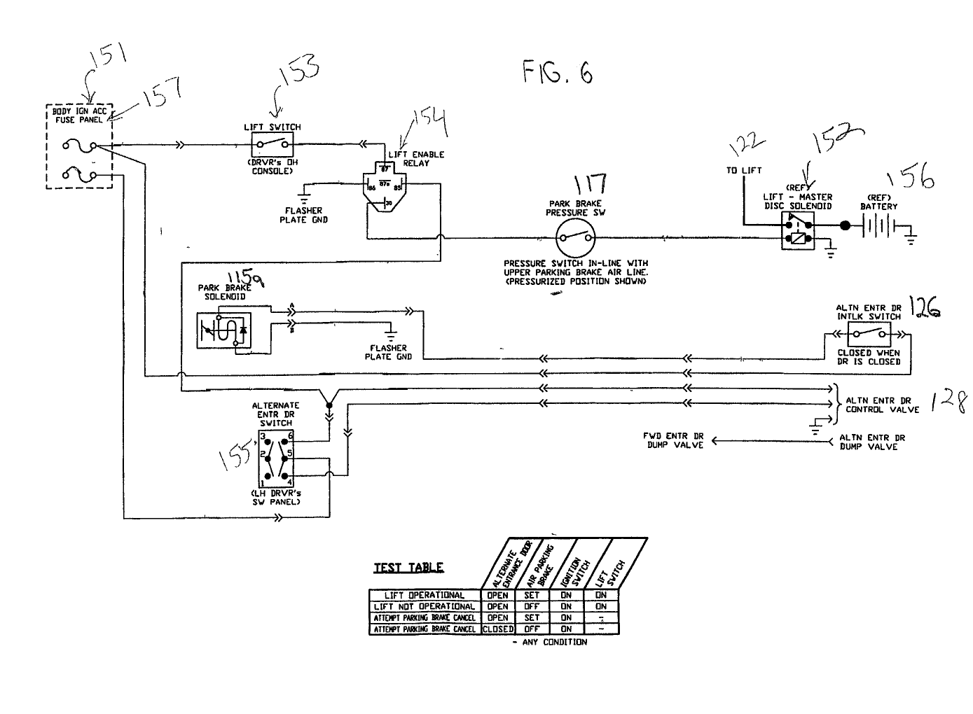

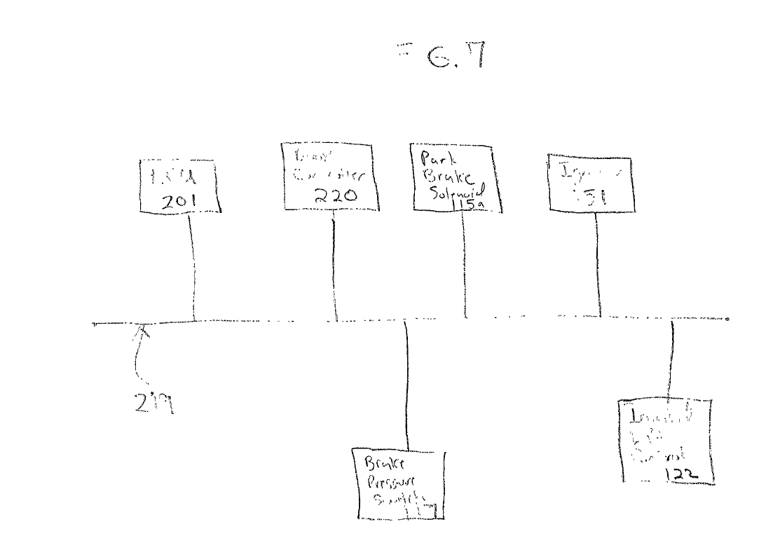

The vehicle 101 will have a body 118 engaged to the chassis 102. The body 118 contains a driver control area 105 and a passenger area. The vehicle ignition 151 is within the driver control area 105. The ignition system 151 provides electrical power to the interlock system in the hard wire embodiment of FIG. 6. The driver control area 105 contains the controls for operating the parking brake system. The body 118 has a lift door access area 119. A lift door 120 is used to close off the lift door access area 119 when an invalid or wheelchair lift 121, also referred to here as an invalift 121, is not in use. The invalift 121 operates through the access area 119. Invalifts 121 in general may operate in various methods. The specific invalift described here is not critical to the invention. The interlock system need only be able to sense the specific invalift parameters and control status in order to achieve the interlock functionality. Similar parameters and control would be available for any invalift. The invalift 121 shown has an operating control 122. The operating control 122 functionality may be achieved through electrical or hydraulic power or some combination. The invalift will have a movement platform 124 for allowing an invalid or wheelchair 191 to be moved onto or off of the vehicle body 118. The movement platform 124 shown is lowered along extending struts 123 which retract into the body 118 through the access area 119 when the invalift 121 is not in use. There may be lift stowed sensor 125 along to detect the invalift 121 in a stowed position. There may be a lift door sensor 126 for sensing the position of the lift door 120. The most important indication being if the lift door 120 is closed. In the invalift 121 shown, the lift door 120 cannot be closed unless the invalift 121 is in a stowed postion. In that embodiment, the lift stowed sensor 125 is not necessary because an indication of lift door 120 closed from the lift door sensor 126 is also an indication that the invalift 121 is stowed.

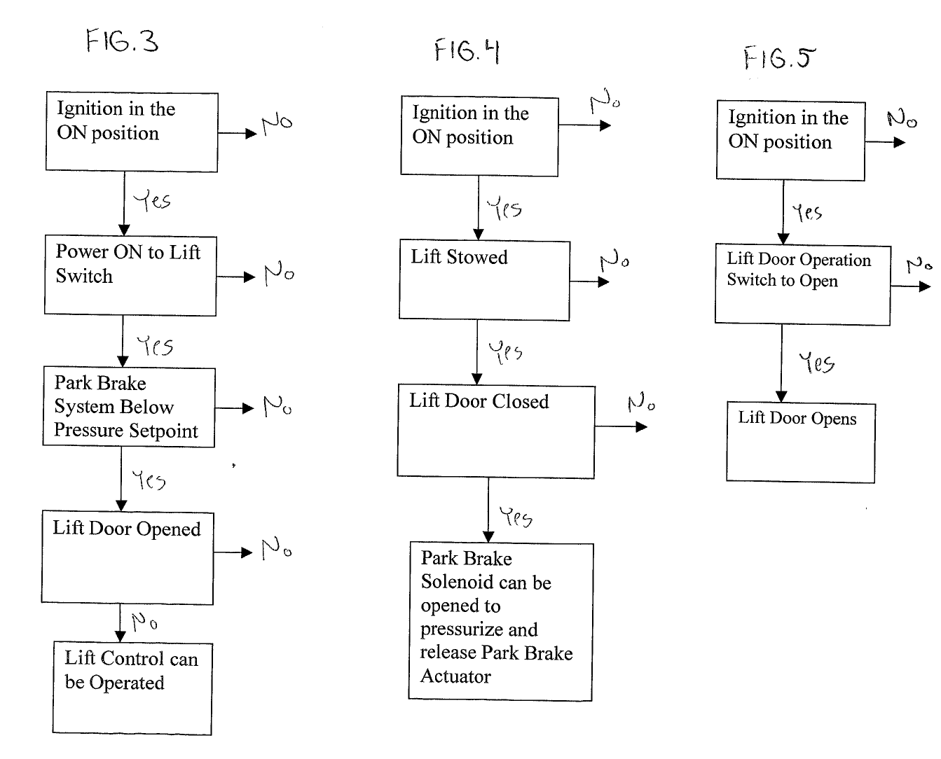

The parking brake invalift interlock system functionality options are shown in FIGS. 3, 4, and 5. The logic diagram of an invalift control portion of the interlock system is shown in FIGS. 3. This is the logic that prevents the operation of the invalift 121 unless a series of conditions exist. For the invalift lift control 152 to be operated, the ignition 151 must be in the ON or energized position. This ignition 151 position also will start the vehicle engine or allow continued operation of the engine or accessories. Additionally, a lift power switch 153 must be ON. Additionally, the park brake system pressure switch 117 must be below a predetermined set point. The predetermined set point is set such that the brake actuator chamber(s) 112 apply the parking brakes. Lastly, the lift door 120 must be opened. If these conditions are met, the series logic will allow a lift control 152 to be operated.

The logic diagram of a parking brake portion of the interlock system is shown in FIG. 4. This is the logic that prevents a driver of the vehicle 101 from moving the vehicle 101 unless a series of conditions exist. For the park brake to be released to allow vehicle 101 movements, the park brake solenoid 115a must be operated to open the park brake valve 115. For the park brake valve 115a to be operated, the ignition 151 must be ON. Additionally, the invalift 121 must be stowed and the lift door 120 must be closed. The door position sensor 126 would provide this indication and hence allow the series logic to be a complete circuit. As mentioned in the embodiment shown, the lift door 120 may not be closed until the invalift 121 is in a stowed position. If the above conditions are met, the park brake solenoid 115a may be operated to open the park brake valve 115 to allow air or operating fluid to overcome potential energy of the brake chambers or actuators 112 to release the park brake.

An additionally option may be to prevent lift door 120 opening unless one condition is met. The logic diagram of an invalift lift door portion of the interlock system is shown in FIG. 5. The ignition 151 must be ON.

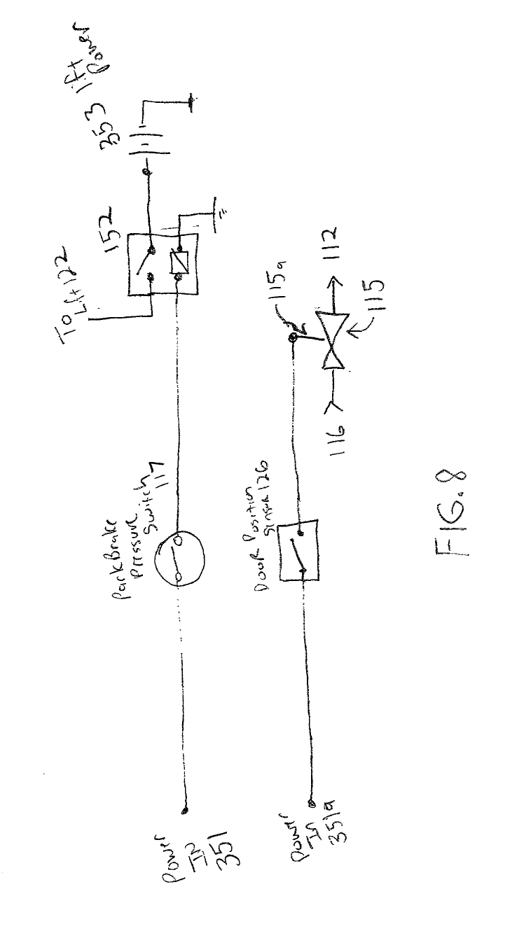

The various parking brake invalift interlock system functionality can be installed in a vehicle 101 through hard wiring such as shown in the preferred embodiment of FIG. 6, the alternative embodiment of FIG. 8, or the interlock system may be the programming of an electronic control unit that is in communication with the sensors and valves and controls such as shown in FIG. 7.

The hard-wired embodiment of FIG. 6 includes the functionality of FIGS. 3, 4, and 5 although some combination that does not include all three may be made. The invalift portion of the functionality of FIG. 3 is shown in the FIG. 6 wiring from the ignition 151 through the lift power switch 153 to a lift enable relay 154. The lift power switch 153 must be closed indicating that there is power to the invalift 121. The lift enable relay 154 will not close to allow ignition power through unless there is closure across contacts 30 to 87. These contacts are not closed across unless a lift door switch 155 is closed by the operation of a lift door 120 control in the driver area 105. The park brake pressure switch 117 must be closed indicating the sensed reduced air or operating fluid pressure in the park brake system. The preferred air embodiment set point will be an air depressurization to between 2 and 6 psig although the pressure must be that which results in the engagement of the park brake. A lift master solenoid 152 acts as the lift control 122 in the embodiment shown. The lift master solenoid cannot be operated unless there is current through the ignition 151, the lift switch 153, the lift enable relay 154 as a result of lift door 120 operation through lift door switch 155, and the park brake switch 117. The series make-up across the sub-circuit of FIG. 6 hence embodies the series logic of FIG. 3.

The parking brake enable portion of FIG. 4 is shown in the FIG. 6 hard-wire embodiment as follows. The ignition 151 must be ON to provide power through a closed lift door 126 sensor. This lift door sensor 126 will be closed when the invalift 121 is stowed and the lift door 120 is closed as described above. This will allow appropriate power through the park brake solenoid 115a allowing release of the park brakes of the vehicle 101.

The lift door interlock portion of FIG. 5 is shown in the FIG. 6 hard-wire embodiment in that the ignition switch 151 must be ON along with the door switch 155 to open to allow operation of a lift door control 128.

The simplest embodiment of this invention would have the park brake pressure switch 117 in series as the sole condition for allowing operation of the invalift 121. Closure of the park brake pressure switch would allow power to flow through a lift control switch 152 from a lift control power supply 353. This simplest embodiment might be somewhat more complex by containing a simple circuit with the door position sensor 126 indicating a closed position providing the sole condition for allowing the park brake solenoid 115a from repositioning the park brake valve 115 from opening and allowing disengagement of the park brake. This simplified embodiment is shown in FIG. 8. There would be a power source 351 or 351a for each logic sub-circuit. These power sources 351 and 351a may be but not necessarily are the same source. The fluid of source 116 need operate only one actuating chamber 112. This could be for operation on a wheel or a drive train component.

In a programmed controller version of the invention, shown in FIG. 7, a vehicle electronic control unit (ECU) 201 is engaged to communicate with a common data link 219 of the vehicle 101. Communication along the data link 219 can be by a multiplexed automotive industry standard such as Society of Automotive Engineers (SAE) J1939 or by a proprietary protocol. There is a door communication controller 220 for the lift door 120; the door communication controller 220 is also engaged to the common data link 219. Lift door switch position may be separately communicated to the common data link through a door position sensor 126 or it may be included within the door communication controller 220. The park brake solenoid or other actuator 115a or the park brake valve 115 may also be engaged to the common data link 219. The ECU 201 may control or have input to park brake valve 115 operation and hence release of the park brake. The park brake pressure switch 117 is also engaged to communicate its status along the common data link 219. The ignition 151 and the invalift lift control 122 are also engaged to communicate on the data link. The logic of FIGS. 3, 4, and 5 may be programmed into the ECU 201. The ECU 201 directs and controls the logic through communication and control signals along the common data link 219. The ECU 201 may be a main vehicle ECU for controlling a number of other vehicle components such as engine, transmission, and anti-lock brake controllers. The simplified logic of the embodiment of FIG. 8 may also be programmed into a multiplexed ECU 201.

As described above, the parking brake invalift interlock system and the vehicle 101 with the interlock system installed provide a number of advantages, some of which have been described above and others of which are inherent in the invention. Also modifications may be proposed to the parking brake invalift interlock system and the vehicle 101 with the interlock system installed without departing from the teachings herein.

We claim:

1. A parking brake invalift interlock system for use in a mobile vehicle, the vehicle having a parking brake that is released upon application of an operating fluid and engaged upon a reduction of operating fluid pressure, the vehicle having a body with a lift door access area with a lift door, and the vehicle having an invalift operable through the lift door, comprising:
an electrical circuit electrically engaged to a vehicle ignition;
a lift power switch in said electrical circuit that is closed when power is applied to the invalift;
a lift enable relay in said electrical circuit that is closed when the lift door is opened;
a park brake pressure switch that is closed when operating fluid pressure is at or below a pressure at which the parking brake is engaged; and
said vehicle ignition, said lift power switch, said lift enable relay, and park brake pressure switch in series allowing the invalift to be operated when said vehicle ignition is ON, and said lift power switch, said lift enable relay, and park brake pressure switch are closed.

2. The parking brake invalift interlock system of claim 1, wherein:
a lift door sensor that provides a closed switch when the invalift is stowed and the lift door closed; and
said lift door sensor switch in series with said ignition allowing the park brake system to be pressurized to release the park brake when said door sensor switch is closed and said ignition is ON.

3. The parking brake invalift interlock system of claim 2, wherein:
said ignition ON providing a circuit in series with a lift door control allowing said lift door control to open the lift door.

4. A parking brake invalift interlock system for use in a mobile vehicle, the vehicle having a parking brake that is released upon application of an operating fluid and engaged upon a reduction of operating fluid pressure, the vehicle having a body with a lift door access area with a lift door, and the vehicle having an invalift operable through the access door, comprising:
a lift door sensor that provides a closed switch when the invalift is stowed and the lift door closed;
said lift door sensor switch in series with said ignition allowing the park brake system to be pressurized to release the park brake when said door sensor switch is closed and said ignition is ON.

5. A mobile vehicle, comprising:
a chassis with a parking brake that is released upon application of an operating fluid and engaged upon a reduction of operating fluid pressure;
a body engaged to said chassis;
said body having a lift door access area with a lift door;
an invalift operable through said lift door;
an electrical circuit electrically engaged to a vehicle ignition in a driver portion of said body;
a lift power switch in said electrical circuit that is closed when power is applied to said invalift;
a lift enable relay in said electrical circuit that is closed when said lift door is opened;
a park brake pressure switch that is closed when operating fluid pressure is at or below a pressure at which said parking brake is engaged; and
said vehicle ignition, said lift power switch, said lift enable relay, and park brake pressure switch in series allowing said invalift to be operated when said vehicle ignition is ON, and said lift power switch, said lift enable relay, and said park brake pressure switch are closed.

6. The vehicle of claim 5, wherein:
a lift door sensor that provides a closed switch when said invalift is stowed and said lift door closed; and
said lift door sensor switch in series with said ignition allowing said park brake fluid to be pressurized to release said park brake when said door sensor switch is closed and said ignition is ON.

7. The vehicle of claim 6, wherein:
said ignition ON providing a circuit in series with a lift door control allowing said lift door control to open said lift door.

8. A mobile vehicle, comprising:
a chassis with a parking brake that is released upon application of an operating fluid and engaged upon a reduction of operating fluid pressure;
a body engaged to said chassis;
said body having a lift door access area with a lift door;
an invalift operable through said lift door;
an electronic control unit is engaged to communicate with a common data link engaged to said chassis and body;
a door communication controller for controlling said lift door;
said door communication controller engaged to said common data link;
lift door switch position communicated along said common data link;
a park brake valve actuator engaged to said common data link;
said ECU may control said park brake valve actuator operation;
a park brake pressure switch engaged to communicate park brake pressure along said common data link;
a vehicle ignition and an invalift lift control engaged to communicate on said data link;
said ECU programming comprised of the steps of:
determining if said ignition is ON;
determining if power applied to said lift control;
determining if park brake pressure is at a pressure at which said park brake is applied;
determining if said lift door is open;
and if said ignition is ON, power is applied to said lift control, said park brake is applied, and said lift door is open, permitting lift control operation;
and if said ignition is not ON, or power is not applied to said lift control, or said park brake is not applied, or said lift door is not open, then preventing operation of said lift control.

9. The vehicle of claim 8, wherein:
said ECU programming comprised of the further steps of:
determining if said ignition is ON;
determining if said invalift is stowed;
determining if said lift door is closed;
and if said ignition is ON, said invalift is stowed, and said lift door is opening, permitting operation of said park brake actuator to open park brake valve to release said park brake;
and if said ignition is not ON, or said invalift is not stowed, or said lift door is not closed, then preventing said park brake actuator from opening said park brake valve.

10. A mobile vehicle, comprising:
a chassis with a parking brake that is released upon application of an operating fluid and engaged upon a reduction of operating fluid pressure;
a body engaged to said chassis;
said body having a lift door access area with a lift door;
an invalift operable through said lift door;
an electronic control unit is engaged to communicate with a common data link engaged to said chassis and body;
a door communication controller for controlling said lift door;
said door communication controller engaged to said common data link;
lift door switch position communicated along said common data link;
a park brake valve actuator engaged to said common data link;
said ECU may control said park brake valve actuator operation;
a vehicle ignition and an invalift lift control engaged to communicate on said data link;
said ECU programming comprised of the steps of:
determining if said ignition is ON;
determining if said invalift is stowed;
determining if said lift door is closed;
and if said ignition is ON, said invalift is stowed, and said lift door is closed, permitting operation of said park brake actuator to open park brake valve to release said park brake;
and if said ignition is not ON, or said invalift is not stowed, or said lift door is not closed, then preventing said park brake actuator from opening said park brake valve.

11. A parking brake invalift interlock system for use in a mobile vehicle, the vehicle having a parking brake that is released upon application of an operating fluid and engaged upon a reduction of operating fluid pressure, the vehicle having a body with a lift door access area with a lift door, and the vehicle having an invalift operable through the lift door, comprising:
a park brake pressure switch that is closed when operating fluid pressure is at or below a pressure at which the parking brake is engaged; and
said park brake pressure switch in series with an invalift lift control to allow lift control operation only when said park brake pressure switch is closed.

12. The system of claim 11, wherein:
a lift door sensor that provides a closed switch when the invalift is stowed and the lift door closed; and
said lift door sensor switch in series with power to a park brake valve actuator of the park brake system to open said park brake valve to pressurize the park brake system and release the park brake when said door sensor switch is closed.

13. A mobile vehicle, comprising:
a chassis with a parking brake that is released upon application of an operating fluid and engaged upon a reduction of operating fluid pressure;
a body engaged to said chassis;
said body having a lift door access area with a lift door;
an invalift operable through said lift door;
a park brake pressure switch that is closed when operating fluid pressure is at or below a pressure at which said parking brake is engaged; and
said park brake pressure switch in series with an invalift lift control to allow lift control operation only when said park brake pressure switch is closed.

14. The vehicle of claim 13, comprising:
a lift door sensor that provides a closed switch when said invalift lift door is closed; and
said lift door sensor switch in series with power to a park brake valve actuator of a park brake system to open said park brake valve to pressurize said park brake system and release said park brake when said door sensor switch is closed.

15. A mobile vehicle, comprising:
a chassis with a parking brake that is released upon application of an operating fluid and engaged upon a reduction of operating fluid pressure;
a body engaged to said chassis;
said body having a lift door access area with a lift door;
an invalift operable through said lift door;
an electronic control unit is engaged to communicate with a common data link engaged to said chassis and body;
a park brake pressure switch engaged to communicate park brake pressure along said common data link;
an invalift lift control engaged to communicate on said data link;
said ECU programming comprised of the steps of:
determining if park brake pressure is at a pressure at which said park brake is applied;
and if said park brake is applied, permitting lift control operation;
and if said park brake is not applied, then preventing operation of said lift control.

16. The vehicle of claim 15, comprising:
lift door switch position communicated along said common data link;
a park brake valve actuator engaged to said common data link;
said ECU may control said park brake valve actuator operation; and
said ECU programming comprised of the further steps of:
determining if said lift door is closed;
and if said lift door is closed, permitting operation of said park brake actuator to open park brake valve to release said park brake;
and if said lift door is not closed, then preventing said park brake actuator from opening said park brake valve.

17. A mobile vehicle, comprising:
a chassis with a parking brake that is released upon application of an operating fluid and engaged upon a reduction of operating fluid pressure;
a body engaged to said chassis;
said body having a lift door access area with a lift door;
an invalift operable through said lift door;
an electronic control unit is engaged to communicate with a common data link engaged to said chassis and body;
lift door switch position communicated along said common data link;
a park brake valve actuator engaged to said common data link;
said ECU may control said park brake valve actuator operation; and
said ECU programming comprising of the steps of:
determining if said lift door is closed;
and if said lift door is closed, permitting operation of said park brake actuator to open park brake valve to release said park brake;
and if said lift door is not closed, then preventing said park brake actuator from opening said park brake valve.
